(19) United States
(12) Patent Application Publication
(10) Pub. No.: US 2022/0384962 A1
(43) Pub. Date: Dec. 1, 2022

(54) A MULTI-UTILITY SIGNAL TRANSMISSION SYSTEM WITH INTEGRATED MODULAR UNITS

(71) Applicant: QOGNO DIGITAL INFRATRUCTURE PVT LTD, Bangalore (IN)

(72) Inventors: Gururaj NAYAK, Bangalore (IN); Abhishek -, Bangalore (IN); Ambarish SAUNGIKAR, Bangalore (IN)

(21) Appl. No.: 17/642,792

(22) PCT Filed: Aug. 25, 2020
(86) PCT No.: PCT/IB2020/057923

§ 371 Date: Mar. 14, 2022

(30) Foreign Application Priority Data
Sep. 12, 2019 (IN) 201941036672

(51) Int. Cl. H01Q 21/00; H01Q 1/24

(52) U.S. Cl. CPC H01Q 21/0025; H01Q 1/246; H04W 88/08

(57) ABSTRACT

The present invention provides a multi-utility signal transmission system with integrated modular units (103). The system (100) comprises an integrated base module (102) which is disposed on a base platform (101) and houses the electronic devices and/or equipment(s) which are required for ensuring optimum functionality of the signal trausmission system. The signal transmission system is built using a plurality of integrated modular units (103) which are stacked one above the other by means of linking points (104) wherein each integrated modular unit (103) comprises linking points (104) and mounting points (105) which enable the fitment of external peripheral devices. The system (100) provides a scalable, adaptable and modular solution for a multi-utility signal communication system to make it feasible, acceptable and relevant to cater to all the infrastructural needs of the signal communication industry and their surrounding establishments.

### DESCRIPTION OF THE INVENTION

### Technical Field of the Invention

The present invention provides a multi-utility signal communication system with integrated modular units. The invention particularly relates to a system for a signal communication system with a plurality of integrated modular units which are stacked one above the other.

### BACKGROUND OF THE INVENTION

Signal communication systems are tall, functional structures that are responsible for housing signal communication devices which enable multi-channel, two-way signal communication between two pre-defined locations or devices, The present generation signal communication systems are single-utility structures that are limited to perform a single function and are incapable of accommodating a plurality of other signal transmission or non-signal transmission equipment(s) to achieve optimum functionality. Further, they are rigidly built structures that cannot be scaled up or scaled down to satisfy specific consumer requirements.

Further, the people who reside in the vicinity of a signal communication systems are susceptible to the risks of various diseases and/or birth defects that are caused as a result of harmful radiations emitted by the present generation signal transmission systems. Currently, there is no mechanism to alert the surrounding public regarding the intensity of radiation emitted or any other functional issue of the signal communication system which demands immediate action for maintenance.

The Patent Application number U.S. Pat. No. 3,768,016A discloses an integrated, modular, prefabricated communications relay system, comprising a plurality of tubular modules prefabricated in a shop facility with the necessary accessory devices therein and assembled in end-to-end relationship at the site of the relay system to provide a complete integrated, modular relay system with the necessary accessory devices and electronic equipment therein.

The Patent Application number U.S. Pat. No. 8,910,432B2 discloses a system structure which comprises a first base plate comprising a first hinge device, a first structural section having a first side and a second side, the first structural section coupled to a second base plate comprising a second hinge device, a second structural section coupled to the first structural section, and an aerial component coupled to the second structural section, wherein the first structural section is rotatable relative to the first base plate in a first rotational axis, the second structural section is rotatable relative to the first structural section in a second rotational axis, and at least a portion of the second structural section is received in a channel formed in the first side of the first structural section when the first structural section and the second structural section are substantially parallel.

Hence, there exists a need for a multi-utility sial communication system which is scalable, adaptable and modular to satisfy specific consumer requirements,

### SUMMARY OF THE INVENTION

The present invention overcomes the drawbacks of the prior art by providing a multi-utility signal communication system with integrated modular units. The system comprises a base platform for supporting the signal. communication system, wherein the signal communication system is built atop the base platform which is primarily a strong foundation built to withstand the entire load of the signal communication system. The base platform is modularly built to allow the attachment of auxiliary components as per requirement. An integrated base module disposed on the base platform houses a maximum number of electronic device(s) and or equipment(s) within a pre-defined threshold limit which are required for ensuring optimum functionality of the signal communication system. Further, the integrated base module also houses electronic equipment(s) for monitoring, communicating, collecting and/or displaying a plurality of process parameters to achieve the required functionality of the signal communication system.

The integrated base module may provide an emergency alerting mechanism which enables statistical data of the signal communication system to be relayed to appropriate governing bodies through multiple modes of communication. Further, the system comprises a plurality of integrated modular units which are independently stacked over the integrated base module. The integrated modular units comprise mechanical and structural elements and may house devices, equipments and/or components such as electronics and so on. Each integrated modular unit comprises linkage points for enabling mechanical linkage between one or more integrated modular units to maintain the structural integrity of the signal communication system. The linkage points enable the erection of the signal. communication system up to a pre-defined height threshold above which the signal communication system is reinforced by a combination of supporting channels, elements and/or mechanisms which allow the sinal communication system to be built above the pre-defined height threshold.

Each integrated modular unit comprises one or more mounting points for enabling the fitment of a plurality of external peripheral devices. Each integrated modular unit also comprises at least one provision for the fitment of at least one or more universal adapters for facilitating the attachment of a plurality of plug and play devices such as digital signages. CCTV surveillance cameras, streetlights, speakers, and so on. The provision for fitment of universal adapters provided with each integrated modular unit are designed to accommodate futuristic devices which enhance the holistic functionality of the signal communication system.

Further, each integrated modular unit facilitates the provision of housing a cable transmission line for transmitting power, data or signal individually to the external peripheral devices which are connected to the signal communication system by means of mounting points and universal adapters. Further, each integrated modular unit comprises a ladder coupled with a provision for a harness unit for enabling maintenance personnel to service existing equipment(s) or install new equipment(s) on the signal communication system.

The system comprises at least one communication device such as a cell-site signal communication device, microwave signal communication device and so on which may be mounted on one of the mounting points of the signal communication system as per the requirement of the user(s). Further, the system comprises an end-cap module disposed on the top-end of the signal communication system. The end cap module shields the signal communication system from damages caused due to a plurality of factors such as severe climatic conditions, harmful radiations and so on. Further, the end cap module may be equipped with a lightning arrestor and/or a warning light which protects the integrated device(s) and equipment(s) from internal/external damages. The end cap module provides utility in a plurality of applications such as a warning light, lighting arrester, drone charging unit and so on and may be customized as per the requirement(s) of the user(s).

The present invention provides a multi-utility signal communication system with integrated modular units. The signal communication system is structurally and aesthetically built and is in-line with the cutting-edge technology driven approach that drives smart cities by bringing about the required combination of utility, form and features to the telecommunication industry. The modularity of the signal communication system enables safe and easy assembly/installation of the signal. communication system up to a pre-defined height threshold. Further, the system comprises a plurality of mounting points for the fitment of signal transmission and non-signal transmission devices such as CCTV surveillance cameras, solar panels, static and digital signage hoards, streetlights, loudspeakers, signal communication devices and so on. The provision for fitment of universal adapters provided with each integrated modular unit are designed to accommodate futuristic devices which enhance the holistic functionality of the signal communication system. The present invention seamlessly blends with the infrastructural ecosystem of a location and is in compliance with safety standards which are pre-defined by appropriate governing bodies.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a perspective view of a multi-utility signal communication system with integrated modular units and an integrated base module.

FIG. 2 illustrates a perspective view of a multi-utility signal communication system erected over the roof-top of a building.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The present invention provides a system for a multi-utility signal communication system with integrated modular units. The system comprises a base platform and an integrated base module which is disposed on the base platform. The integrated base module houses the electronic equipment(s) which are required for ensuring optimum functionality of the signal, communication system. The signal communication system is built using a plurality of integrated modular units which are stacked one above the other by means of linking points wherein each integrated modular unit comprises linking points and mounting points which enable the fitment of external peripheral devices. Further, each integrated modular unit comprises a provision for the fitment of one or more universal adapters which facilitate the attachment of plug and play devices.

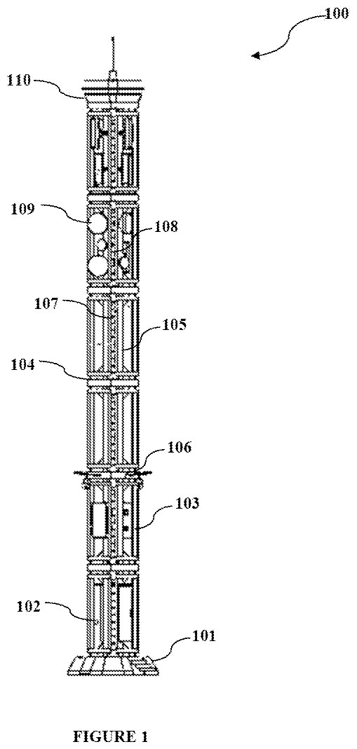

FIG. 1 illustrates a multi-utility signal communication system with integrated modular units. The system (190) comprises a base platform (101) for supporting the signal communication system, wherein the signal communication system is built atop the base platform (101) which is primarily a strong foundation built to withstand the entire load of the signal communication system. In one embodiment, the rooftop of an existing building may provide the utility of the base platform (101) which ensures that the signal communication system may be installed in densely populated areas without the requirement of additional infrastructure to ensure that the signal communication system is securely fixed to the base platform (101). Further, the base platform (101) is modularly built to allow the attachment of auxiliary components as per requirement. An integrated base module (102) disposed on the base platform (101) houses a maximum number of electronic device(s) and/or equipment(s) within a pre-defined threshold limit which are required for ensuring optimum functionality of the signal communication system. Further, the integrated base module (102) also houses electronic equipment(s) for monitoring, communicating, collecting and/or displaying a plurality of process parameters to achieve the required functionality of the signal communication system.

According to one or more embodiments of the present invention, the integrated base module (102) provides an emergency alerting mechanism which enables statistical data of the signal communication system to be relayed to appropriate governing bodies through multiple modes of communication for applications such as alerting of emergencies, monitoring, troubleshooting and so on. Further, the system (100) comprises a plurality of identical integrated modular units (103) which are independently stacked over the integrated base module (102), wherein the integrated base module (102) is also an integrated modular unit (103) which has the utility of ensuring the safe functionality of the signal communication system. In another embodiment, the system (100) also allows the assembly of the integrated modular units (103) in a horizontal manner or at a pre-defined angular manner prior to erecting the signal communication system atop the base platform (101). The system (100) may be assembled andlor erected by utilizing specific tools and/or mechanisms Which facilitate quick assembly of the signal communication system thereby ensuring minimum human intervention.

According to one or more embodiments of the present invention, each integrated modular unit (103) comprises linkage points (104) for enabling mechanical linkage between one or more integrated modular units (103) to maintain the structural integrity of the communication system. The linkage points (104) enable the erection of the signal communication system up to a pre-defined height threshold above which the signal communication system is reinforced by a combination of supporting channels, elements and/or mechanisms which allow the signal communication system to be built above the pre-defined height threshold.

According to one or more embodiments of the present invention, each integated modular unit (103) comprises one or more mounting points (105) for enabling the fitment of a plurality of external peripheral devices such as static and digital signage boards, signal communication devices and so on. Each integrated modular unit (103) also provides the facility for hosting at least one universal adapter (106) for facilitating the attachment of a plurality of plug and play devices such as CCTV surveillance cameras, streetlights, loudspeakers, solar panels and so on. The provision for the fitment of one or more universal adapters (106) provided with each integrated modular unit (103) are also designed to accommodate futuristic devices which enhance the holistic functionality of the signal communication system.

According to one or more embodiments of the present invention, each integrated modular unit (103) facilitates the provision of housing a cable transmission line (107) for transmitting power, data and/or signals individually to the external peripheral devices which are connected to the signal communication system by means of mounting points (105) and universal adapters (106). Further, each integrated modular unit (103) may comprise a ladder coupled with a provision for a harness unit (108) for enabling maintenance personnel to access different sections of the signal communication system for the purpose of servicing and maintenance related activities or installation of new equipment(s) on the signal communication system.

The system (100) comprises at least one signal communication device (109) such as a cell-site antenna, microwave antenna and so on which may be mounted on one of the mounting points (105) of the signal communication system as per the requirement of the user(s). Further, the system (100) comprises an end-cap module (110) disposed on the top-end of the signal communication system. In one embodiment, the end cap module (110) shields the signal communication system from a plurality of factors such as severe climatic conditions, harmful radiations and so on. Further, the end cap module (110) may enable the user(s) to take proactive decisions by generating alerts based on the gravity of the circumstances. The end cap module provides utility in a plurality of applications such as a warning light, lighting arrester, drone charging unit and so on and may be customized as per the requirement(s) of the user(s).

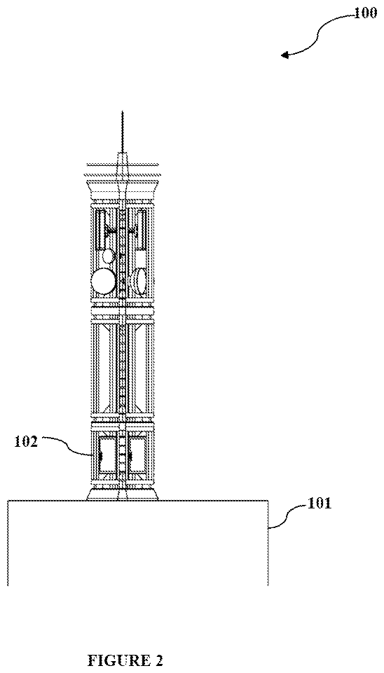

FIG. 2 illustrates a perspective view of a multi-utility signal communication system erected over the roof-top of a building wherein, the rooftop of an existing building may provide the utility of the base platform (101) which ensures that the signal communication system may be installed in densely populated areas without the requirement of additional infrastructure to ensure that the signal communicati©n system is securely fixed to the base platform (101).

The present invention provides a multi-utility signal communication system with integrated modular units. The signal communication system is structurally and aesthetically built and is in-line with the cutting-edge technology driven approach that drives smart cities by bringing about the required combination of utility, form and features to the telecommunication industry. The modularity of the signal communication system enables safe and easy assembly/installation of the signal communication system up to a pre-defined height threshold.

Further, the system comprises a plurality of mounting points for the fitment of signal transmission and non-signal transmission devices such as CCTV surveillance cameras, solar panels, static and digital signage boards, streetlights, loudspeakers, signal communication devices and so on. The provision for fitment of universal adapters provided with each integrated modular unit are designed to accommodate futuristic devices which enhance the holistic functionality of the signal communication system. The present invention seamlessly blends with the infrastructural ecosystem of a location and is in compliance with safety standards which are pre-defined by appropriate governing bodies.

While at least one exemplary embodiment has been presented in the foregoing detailed description, it should be appreciated that a vast number of variations exist.

### REFERENCE NUMBERS

| Components | Reference Numbers |
|---|---|
| System | 100 |
| Base platform | 101 |
| Integrated base module | 102 |
| Integrated modular unit | 103 |
| Linkage points | 104 |
| Mounting points | 105 |
| Universal adapter | 106 |
| Cable transmission line | 107 |
| Ladder coupled with a harness unit | 108 |
| Signal communication device | 109 |
| End-cap module | 110 |

We claim:

1. A multi-utility signal communication system with integrated modular units, the system (100) comprising:
a. a base platform (101) for supporting a signal communication system, wherein the signal communication system is built atop the base platform (101);
b. an integrated base module (102) disposed on the base platform (101), wherein the integrated base module (102) houses electronic devices and equipments, which are required for ensuring optimum functionality of the signal communication system;
c. at least one integrated modular unit (103) disposed on the integrated base module (102), wherein the integrated modular unit (103) comprises:
i. linkage points (104) for enabling mechanical linkage between one or more integrated modular units (103);
ii. mounting points (105) for enabling the fitment of external peripheral devices;
iii. a provision for fitment of at least one universal adapter (106) for facilitating the attachment of a plurality of plug and play devices;
iv. a cable transmission line (107) for transmitting power, data and/or signal individually to the external peripheral devices which are connected to the signal communication system by means of mounting points (105) and universal adapter (106);
v. a ladder coupled with a provision for a harness unit (108) for enabling maintenance personnel to access different sections of the signal communication system;
d. at least one signal communication device (109) mounted on one of the mounting points (105) provided with the integrated modular units (103) of the signal communication system;
e. an end-cap module (110) which is disposed at the top-end of the signal transmission system, wherein the utility of the end-cap module is customized based on the user's requirement.

2. The system (100) as claimed in claim 1, wherein the integrated base module (102) is designed to accommodate a maximum number of electronic equipment(s) within a pre-defined threshold limit.

3. The system (100) as claimed in claim 1, wherein the integrated base module (102) provides for a mechanism which enables statistical data of the signal communication system to be relayed to appropriate governing bodies through multiple modes of communication.

4. The system (100) as claimed in claim 1, wherein the integrated modular units (103) are:
identical elements which are independent of one another; and
stacked one above the other by means of linking points (104) up to a pre-determined height as per the requirement of one or more users.

5. The system (100) as claimed in claim 1, wherein the integrated modular units (103) enable the fitment of external peripheral devices through mounting points (105) and facility for hosting universal adapters (106) provided on each integrated modular unit (103).

6. The system (100) as claimed in claim 1, wherein the integrated modular units (103) are stacked one above the other up to a pre-defined height threshold above which the signal communication system is reinforced by a combination of supporting channels, elements and mechanisms which allow the signal communication system to be built above the pre-defined height threshold.
